(19) United States
(12) Patent Application Publication
(10) Pub. No.: US 2017/0039921 A1
(43) Pub. Date: Feb. 9, 2017

(54) Pixel Structure and Driving Method Thereof, Array Substrate and Display Device

(71) Applicants: BOE TECHNOLOGY GROUP CO., LTD., Beijing (CN); ORDOS YUANSHENG OPTOELECTRONICS CO., LTD., Ordos, Inner Mongolia (CN)

(72) Inventors: Yanqing CHEN, Beijing (CN); Xuelu WANG, Beijing (CN)

(73) Assignees: BOE TECHNOLOGY GROUP CO., LTD.; ORDOS YUANSHENG OPTOELECTRONICS CO., LTD.

(21) Appl. No.: 14/913,071

(22) PCT Filed: Aug. 19, 2015
(86) PCT No.: PCT/CN2015/087508

§ 371 Date: Feb. 19, 2016

(30) Foreign Application Priority Data
Mar. 11, 2015 (CN) 201510106616.1

(51) Int. Cl. G09G 3/20; G02F 1/1343

(52) U.S. Cl. CPC G09G 3/2003; G09G 3/2074; G02F 1/134363; G09G 2320/0276; G09G 2320/0666; G09G 2300/0452; G02F 2001/134345

(57) ABSTRACT

Embodiments of the present invention disclose a pixel structure and a driving method thereof, an array substrate and a display device, relating to the technical field, of display. By making brightness ratios of sub-pixels of different colors consistent in different gray scales without reducing the brightness of a displayed image, the quality of the displayed image is improved. The pixel structure comprises sub-pixels of at least two colors, each of the sub-pixels comprising a plate electrode and a slit electrode provided to be insulated from each other. The slit electrodes included in the sub-pixels of different colors are configured to have different structures, to make voltage-transmittance curves of the sub-pixels of different colors consistent.

### FIELD OF THE INVENTION

The present invention relates to the technical field of display, particularly to a pixel structure and a driving method thereof, an array substrate and a display device.

### BACKGROUND OF THE INVENTION

A liquid crystal display (LCD) includes sub-pixels of different colors. The sub-pixels of different colors generally have different voltage-transmittance curves (as shown in FIG. 8), leading to different respective saturation voltages and thus brightness ratios of the sub-pixels of different colors are different in different gray scales.

Specifically, for example in an LCD including a slit electrode in the pixel structure, such as an In-Plan Switching (IPS) LCD, an Advanced. Super Dimension Switch (simply referred to as ADS) LCD, in a case of including a red sub-pixel, a green sub-pixel and a blue sub-pixel, the red sub-pixel, the green sub-pixel and the blue sub-pixel are different in brightness ratios in different gray scales. For example, when in a certain low gray scale, the brightness ratio of the red sub-pixel to the green sub-pixel to the blue sub-pixel is 1:5:0.2, and the Chromaticity coordinates of a white light obtained by mixing lights emitted from the red sub-pixel, the green pixel and the blue pixel are (0.300,0.320); when in a certain high gray scale, the brightness ratio of the red sub-pixel to the green sub-pixel to the blue sub-pixel is 1:6;0.2, i.e., the brightness ratio of the green alb-pixel increases, and chromaticity coordinates of a white light obtained by mixing lights emitted from the red sub-pixel, the green pixel and the blue pixel is (0.310,0.330). Thus, during the viewing of a user, some of the white parts in a displayed image appear bluish while some appear yellowish, resulting in poor color reproduction and undesirable quality of a displayed image.

### SUMMARY OF THE INVENTION

To allow white parts of a displayed image viewed by a user to have appropriate and consistent colors in any gray scales in order to realize the ideal quality of the displayed image, it is usually necessary to perform gamma correction on the image data before the displayed image has been output by the LCD. In the prior art, a red sub-pixel, a green sub-pixel and a blue sub-pixel are corrected by using different gamma curves, respectively, to make the bright ratios of the red sub-pixel to the green sub-pixel to blue sub-pixel consistent in a high gray scale and a low gray scale. However, the inventor has found that, after performing gamma correction on the LCD by using the foregoing method, the transmittance of the LCD is decreased, thus the brightness of the displayed image is decreased, so that the quality of the displayed image of the LCD is still not ideal.

In view of the foregoing problems in the prior art, the present invention provides a pixel structure and a driving method thereof, an array substrate and a display device. By making brightness ratios of sub-pixels of different colors consistent in different gray scales without reducing the brightness of a displayed image, the quality of the displayed image of the LCD can be improved.

The embodiments of the present invention provide a pixel structure, including sub-pixels of at least two colors, each of the sub-pixels including a plate electrode and a slit electrode provided to be insulated from each other. The slit electrodes included in the sub-pixels of different colors are configured to have different structures, to make voltage-transmittance curves of the sub-pixels of different colors consistent.

Preferably, at least one of the widths of electrodes, the widths of slits and the included angles between the slits and the arrangement directions of the sub-pixels, of the slit electrodes included in the alb-pixels of different colors, are different.

Preferably, the included angles between the slits of the slit electrodes included in the sub-pixels of different colors and the arrangement directions of the sub-pixels are the same, the sums of the widths of electrodes and the widths of slits of the slit electrodes included, in the sub-pixels of different colors are the same, and both the widths of electrodes and the widths of slits of the slit electrodes included in the sub-pixels of different colors are different.

Preferably, the pixel structure includes a red sub-pixel, a green sub-pixel, and a blue sub-pixel; and the red sub-pixel includes a first slit electrode, the green sub-pixel includes a second slit electrode, and the blue sub-pixel includes a third slit electrode.

Preferably, the included angles between slits of the first slit electrode, the second slit electrode and the third slit electrode and the arrangement directions of the sub-pixels are the same, the sums of the widths of electrodes and the widths of slits of the first slit electrode, the second slit electrode and the third slit electrode are the same, the widths of electrodes of the first slit electrode, the second slit electrode and the third slit electrode increase in this order, and the widths of slits of the first slit electrode, the second slit electrode and the third slit electrode decrease in this order.

Preferably, the width of each of the red sub-pixel, the green sub-pixel and the blue sub-pixel is 26 μm, and the length thereof is 78 μm, and the sum of the width of electrode and the width of slit of each of the first slit electrode, the second slit electrode and the third slit electrode is 6.2 μm; the width of electrode of the first slit electrode is 1.8 μm, and the width of slit of the first slit electrode is 4.4 μm; the width of electrode of the second slit electrode is 2.1 μm, and the width of slit of the second slit electrode is 4.1 μm; and the width of electrode of the third slit electrode is 2.8 μm, and the width of slit of the third slit electrode is 3.4 μm.

Preferably, the included angles between slits of the slit electrodes included in the sub-pixels of different colors and the arrangement directions of the sub-pixels are the same, the sums of the widths of electrodes and the widths of slits of the slit electrodes included in the sub-pixels of different colors are different, and both the widths of electrodes and the widths of Slits of the slit electrodes included in the sub-pixels of different colors are different.

Preferably, the pixel structure includes a red sub-pixel, a green sub-pixel, and a blue sub-pixel; the red sub-pixel includes a first slit electrode, the green sub-pixel the width of each of the red sub-pixel, the green sub-pixel and the blue sub-pixel is 26 μm, and length thereof is 78 μm; the sum of the width of electrode and the width of slit of the first slit electrode is 5.1 μm, the width of electrode of the first slit electrode is 2.1 μm, and the width of slit of the first slit electrode is 3.0 μm; the sum of the width of electrode and the width of slit of the second slit electrode is 5.9 the width of electrode of the second slit electrode is 2.3 μm, and the width of slit of the second slit electrode is 3.6 μm; and the sum of the width of electrode and the width of slit of the third slit electrode is 6.2 μm, the width of electrode of the third slit electrode is 2.8 μm, and the width of slit of the third slit electrode is 3.4 μm.

Preferably, the included angles between slits of the slit electrodes included in the sub-pixels of different colors and the arrangement direction of the sub-pixel are different, and any of the widths of electrodes and the widths of slits of the slit electrodes included in the sub-pixels of different colors are the same, or both of the widths of electrodes and the widths of slits of the slit electrodes included in the sub-pixels of different colors are different.

A pixel structure according to the embodiments of the present invention includes sub-pixels of at least two colors, each of the sub-pixels including a plate electrode and a slit electrode provided to be insulated from each other. The slit electrodes included in the sub-pixels of different colors are configured to have different structures, to make voltage-transmittance curves of the sub-pixels of different colors consistent. Hence, the saturation voltages of the sub-pixels of different colors are the same. Therefore, the sub-pixels of different Mors can be subjected to gamma correction by using a same gamma curve. Consequently, it is ensured that the transmittance of the LCD will not be reduced after the gamma correction while the brightness ratios of sub-pixels of different colors are made consistent in different gray scales, so that the brightness of a displayed image is high and the quality of the image displayed on the LCD is ideal.

In addition, the embodiments of the present invention further provide an array substrate including any one of the above pixel structures. Compared with the prior art, the array substrate according to embodiments of the present invention can make brightness ratios of sub-pixels of different colors consistent in different gray scales without reducing the brightness of a displayed image, so that the quality of the image displayed on the LCD is improved.

In addition, the embodiments of the present invention further provide a display device including the array substrate as described above. Compared with the prior art, the display device according to embodiments of the present invention can make brightness ratios of sub-pixels of different colors consistent in different gray scales without reducing the brightness of a displayed image, so that the quality of the displayed image is improved.

In addition, the embodiments of the present invention further provide a method of driving a pixel structure, used for driving the pixel structure according to the embodiments of the present invention. The driving method includes: performing gamma correction on the sub-pixels of different colors by using a same gamma curve. Compared with the prior art, by the method for driving the pixel structure according to the embodiments of the present invention, the brightness ratios of sub-pixels of different colors are made consistent in different gray scales in a simpler manner without reducing the brightness of a displayed image, and the quality of the image displayed on the LCD is thus improved.

### BRIEF DESCRIPTION OF THE DRAWINGS

To explain the technical solutions of the present invention more clearly, the embodiments of the present invention will be described below in conjunction with the accompanying drawings. Apparently, the drawings described below are merely some embodiments of the present invention, and for a person of ordinary skill in the art, other drawings may also be obtained according to these drawings without any creative effort.

FIG. 1 is a plan schematic view of a pixel structure according to an embodiment of the present invention;

FIG. 2 is a sectional schematic view of sub-pixels of different colors of FIG. 1 along direction A-A′;

FIG. 3 is a schematic of voltage-transmittance curves of sub-pixels of different colors of FIG. 1;

FIG. 4 is a plan schematic view of a pixel structure according to another embodiment of the present invention;

FIG. 5 is a sectional schematic view of sub-pixels of different colors of FIG. 4 along direction B-B′;

FIG. 6 is a schematic view of voltage-transmittance curves of sub-pixels of different colors of FIG. 4;

FIG. 7 is a schematic view of a method for driving the pixel structure according to an embodiment of the present invention; and

FIG. 8 is a schematic view of voltage-transmittance curves of sub-pixels of different colors in the prior art.

Reference numerals:

| | | |
|---|---|---|
| 1: red sub-pixel; | 11: first slit electrode | 2: green sub-pixel; |
| 21: second slit electrode; | 3: blue sub-pixel; | 31: third slit electrode |

### DESCRIPTION OF THE PREFERRED EMBODIMENT

Embodiments of the present invention will be described clearly and completely in conjunction with the accompanying drawings. Apparently, embodiments described herein are merely some but not all of embodiments of the present invention. Based on the embodiments of the present invention, all other embodiments made by a person of ordinary skill in the art without any creative effort are within the protection scope of the present invention.

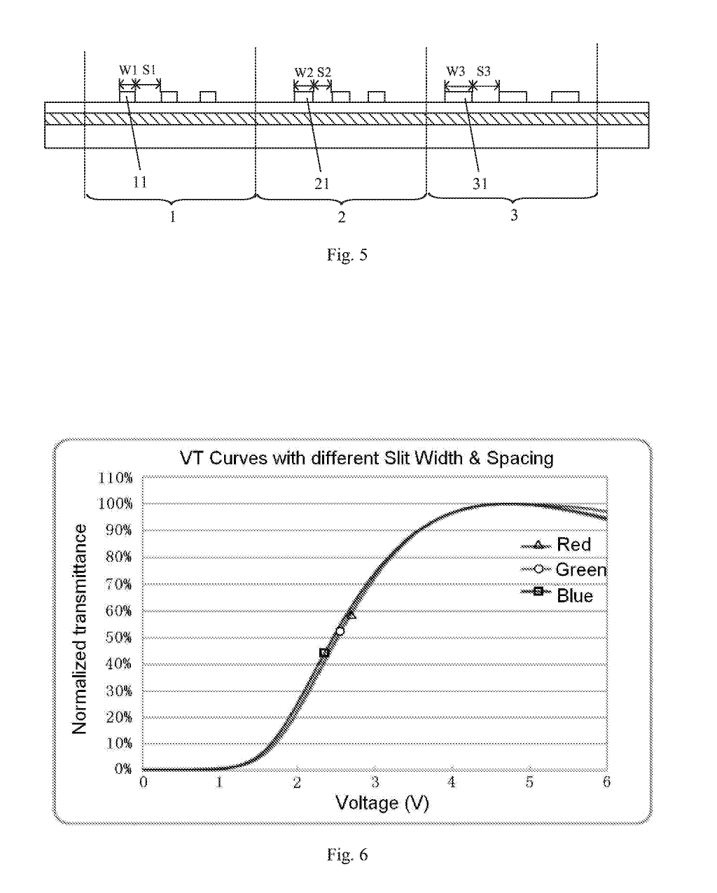

Embodiments of the present invention provide a pixel structure. Specifically, the pixel structure includes sub-pixels of at least two colors, each of the sub-pixels including a plate electrode (shaded portion in FIG. 2 and FIG. 5) and a slit electrode provided to be insulated from each other, wherein the slit electrodes included in the sub-pixels of different colors are configured to have different structures to make voltage-transmittance curves of the sub-pixels of different colors consistent. In this case, the saturated voltages of the sub-pixels of different colors are the same. Therefore, the sub-pixels of different colors can be subjected to gamma correction by using a same gamma curve. Consequently, the transmittance of the LCD will not be reduced after the gamma correction, so that the brightness of a displayed image is high and the quality of the image displayed on the LCD is ideal.

It should be noted that, the plate electrode described above may be a common electrode or pixel electrode, and correspondingly, the slit electrode described above may be a pixel electrode or a common electrode, as long as it is ensured that the electrode close to the liquid crystal molecules is a slit electrode. In the embodiments of the present invention, preferably, the plate electrode is a common electrode and the slit electrode is a pixel electrode.

Specifically, “the slit electrodes included in the sub-pixels of different colors are configured to have different structures” may be: at least one of widths of electrodes, widths of slits and included angles between the slits and arrangement directions of the sub-pixels, of the slit electrodes included in the sub-pixels of different colors, are different. In an example, the included angles between the slits of the slit electrodes included in the sub-pixels of different colors and the arrangement directions of the sub-pixels are configured to be the same, the sums of widths of electrodes and widths of slits of the slit electrodes included in the sub-pixels of different colors are configured to be the same, whereas the widths of electrodes/slits of the slit electrodes included in the sub-pixels of different colors are different. In another example, the included angles between the slits of the slit electrodes included in the sub-pixels of different colors and the arrangement directions of the sub-pixels are configured to be the same, the sums of widths of electrodes and widths of slits of the slit electrodes included in the sub-pixels of different colors are configured to be different, and both widths of electrodes and widths of slits of the slit electrodes included in the sub-pixels of different colors are different. In still another example, the included angles between the slits of the slit electrodes included in the sub-pixels of different colors and the arrangement directions of the sub-pixels are configured to be different, and any of widths of electrodes and widths of slits of the slit electrodes included in the sub-pixels of different colors are the same or both of widths of electrodes and widths of slits of the slit electrodes included in the sub-pixels of different colors are different. Apparently, the present invention is not limited thereto.

The preferred embodiments of the present invention will be described in detail as below in conjunction with the accompanying drawings by taking a pixel structure including a red sub-pixel, a green sub-pixel and a blue sub-pixel as an example.

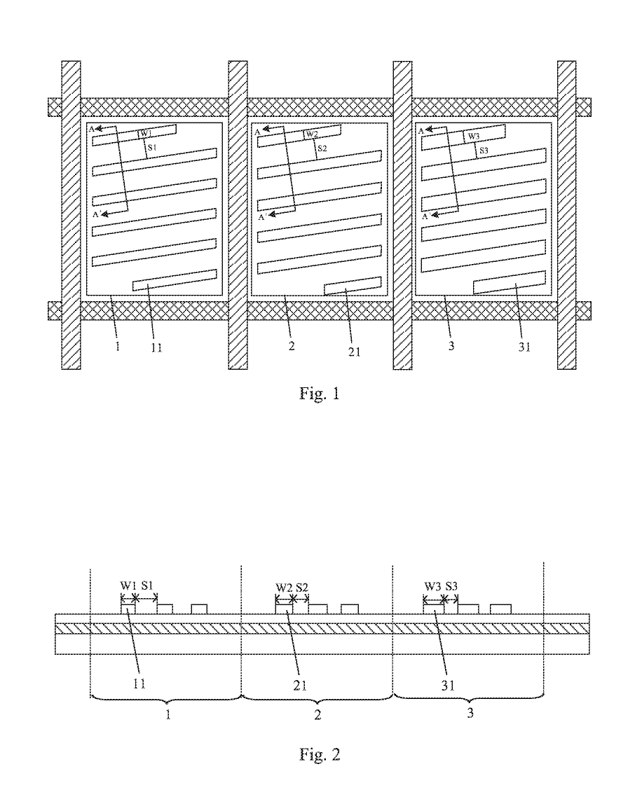

FIG. 1 is a plan schematic view of a pixel structure according to an embodiment of the present invention. As shown in FIG. 1, the pixel structure includes a red sub-pixel 1, a green alb-pixel 2 and a blue sub-pixel 3, wherein the red sub-pixel 1 includes a first slit electrode 11, the green sub-pixel 2 includes a second slit electrode 21, and the blue sub-pixel 3 includes a third slit electrode 31.

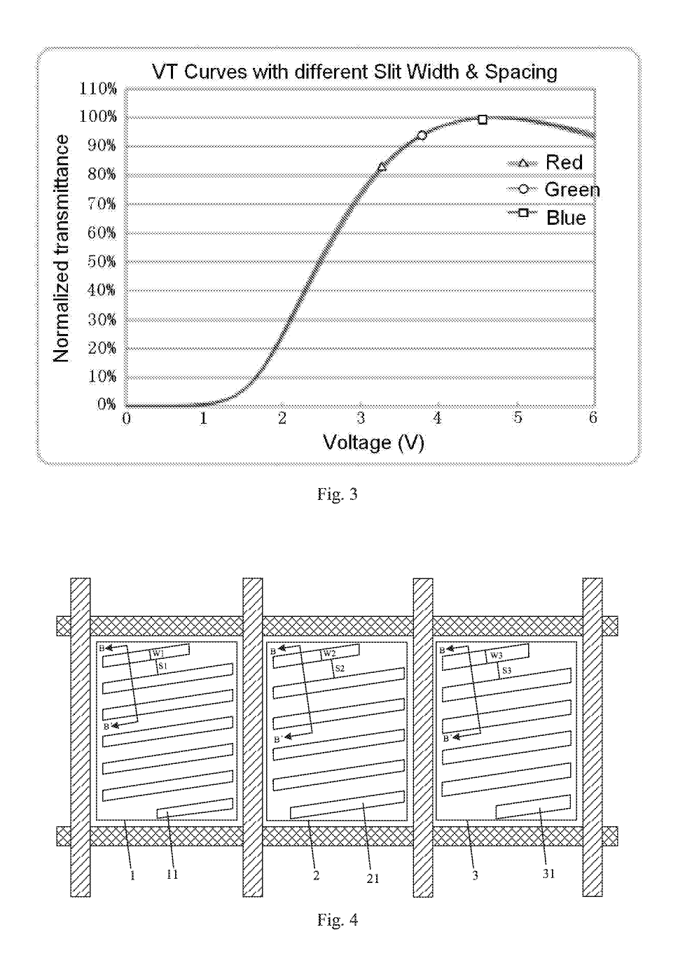

FIG. 2 is a sectional schematic view of sub-pixels of different colors of FIG. 1 along a direction A-A′. As shown in FIG. 1 and FIG. 2, the included angles between slits of the first slit electrode 11, the second slit electrode 21 and the third slit electrode 31 and the arrangement directions of the sub-pixels are the same, the sums of widths of electrodes (i.e., the width of an individual electrode in each slit electrode) and widths of slits (i.e., the width of an individual slit in each slit electrode) of each of the first slit electrode 11, the second slit electrode 21 and the third slit electrode 31 are the same (W1+S1=W2+S2=W3+S3), and both the widths of electrodes and the widths of slits of the first slit electrode 11, the second slit electrode 21 and the third slit electrode 31 are different (W1≠W2≠W3, and S1≠S2≠S3), in order to make voltage-transmittance curves of the red sub-pixel 1, the green sub-pixel 2 and the blue sub-pixel 3 consistent. Now, the voltage-transmittance curves of the red sub-pixel 1, the green sub-pixel. 2 and the blue sub-pixel 3 are as shown in FIG. 3.

The voltage-transmittance curves of the red sub-pixel, the green sub-pixel and the blue sub-pixel in the prior art are as shown in FIG. 8. It can be seen from FIG. 8 that, as the voltage increases, the increase ratio of the transmittance of the red sub-pixel is the maximum and the increase ratio of the transmittance of the blue sub-pixel is widths of electrodes of the first slit electrode 11, the second slit electrode 21 and the third slit electrode 31 are configured to increase in this order, and the widths of slits of the first slit electrode 11, the second slit electrode 21 and the third slit electrode are configured to decrease in this order, in order to make the voltage-transmittance curves of the red sub-pixel 1, the green sub-pixel 2 and the blue sub-pixel 3 consistent (as shown in FIG. 3).

In a specific example, each of the red sub-pixel 1, the green sub-pixel 2 and the blue sub-pixel 3 is configured to have a width of 26 μm and a length of 78 μm, and the sum of width of electrode and width of slit of each of the first slit electrode 11, the second slit electrode 21 and the third slit electrode 31 is set as 6.2 μm.

The width W1 of electrode of the first slit electrode 11 is 1.8 μm, and width S1 of slit of the first slit electrode 11 is 4.4 μm.

The width W2 of electrode of the second slit electrode 21 is 2.1 μm, and width S2 of slit of the second slit electrode 21 is 4.1 μm.

The width W3 of electrode of the third slit electrode 31 is 2.8 μm, and width S3 of slit of the third slit electrode 31 is 3.4 μm.

It should be noted that, the sizes of the red sub-pixel 1, the green sub-pixel 2 and the blue sub-pixel 3 in this embodiment are not limited thereto. Meanwhile, the structures of the first slit electrode 11, the second slit electrode 21 and the third slit electrode 31 are not limited to the above specific sizes. The structures of the first slit electrode 11, the second slit electrode 21 and the third slit electrode 31 should change correspondingly, when the sizes of the red sub-pixel 1, the green sub-pixel 2 and the blue sub-pixel 3 change. Repeated description will not be given herein.

FIG. 4 is a plan schematic view of a pixel structure according to another embodiment of the present invention. FIG. 5 is a sectional schematic view of sub-pixels of different colors of FIG. 4 along a direction As shown in FIG. 4 and. FIG. 5, the included angles between slits of the first slit electrode 11, the second slit electrode 21 and the third slit electrode 31 and the arrangement directions of the first slit electrode 11, the second slit electrode 21 and the third slit electrode 31 are different (W1+S1≠W2+S2≠W3+S3), and both the widths of electrodes and the widths of slits of the first slit electrode 11, the second electrode 21 and the third slit electrode 31 are different (W1≠W2≠W3, and S1≠S2≠S3), in order to make voltage-transmittance curves of the red sub-pixel 1, the green sub-pixel 2 and the blue sub-pixel 3 consistent. Now, the voltage-transmittance curves of the red sub-pixel 1, the green sub-pixel 2 and the blue sub-pixel 3 are as shown in FIG. 6.

In a specific example, each of the red sub-pixel 1, the green sub-pixel 2 and the blue sub-pixel 3 is configured to have a width of 26 μm and a length of 78 μm.

The sum of width of electrode and width of slit of the first slit electrode 11 is 5.1 μm, the width W1 of electrode of the first slit electrode 11 is 2.1 μm, and width S1 of slit of the first slit electrode 11 is 3.0 μm.

The sum of width of electrode and width of slit of the second slit electrode 21 is 5.9 μm, the width W2 of electrode of the second slit electrode 21 is 2.3 μm, and the width S2 of slit of the second slit electrode 21 is 3.6 μm.

The sum of width of electrode and width of slit of the third slit electrode 31 is 6.2 μm, the width W3 of electrode of the third slit electrode 31 is 2.8 μm, and the width S3 of slit of the third slit electrode 31 is 3.4 μm.

It should be noted that, the sizes of the red sub-pixel 1, the green sub-pixel 2 and the blue sub-pixel 3 in this embodiment are not limited thereto. Meanwhile, the structures of the first slit electrode 11, the second slit electrode 21 and the third slit electrode 31 are not limited to the above specific sizes. The structures of the first slit electrode 11, the second slit electrode 21 and the third slit electrode 31 should change correspondingly, when the sizes of the red sub-pixel 1, the green sub-pixel 2 and the blue sub-pixel 3 change. Repeated description will not be given herein.

Although the preferred embodiments of the present invention have been described by taking a pixel structure including a red sub-pixel, a green sub-pixel and a blue sub-pixel as an example, it may be envisaged that the present invention is not limited to the above example, and instead, the present invention may be applied to other pixel structures including sub-pixels of other colors. For example, the pixel structure may include sub-pixels of four colors, i.e., C (cyan), M (magenta), Y (yellow) and G (green), or may include sub-pixels of four colors, i.e., R (red), G (green), B (blue) and E (emerald).

The embodiments of the present invention provide a pixel structure. Specifically, the pixel structure includes sub-pixels of at least two colors, each of the sub-pixels including a plate electrode and a slit electrode provided, to be insulated from each other, wherein the slit electrodes included in the sub-pixels of different colors are configured to have different structures to make voltage-transmittance curves of the sub-pixels of different colors consistent. Hence, the saturated voltages of the sub-pixels of different colors are the same. Therefore, the sub-pixels of different colors can be subjected to gamma correction by using a same gamma curve. Consequently, the transmittance of the LCD will not be reduced after the gamma correction, so that the brightness of a displayed image is high and the quality of the image displayed on the LCD is ideal.

In addition, the embodiments of the present invention further provide an array substrate including the pixel structure according to the embodiments of the present invention.

The embodiments of the present invention further provide a display device including the array substrate as described above. The display device may be a liquid crystal panel, electronic paper, a mobile phone, a tablet computer, a TV set, a display, a notebook computer, a digital photo frame, a navigation instrument, and any other products or components having a display function.

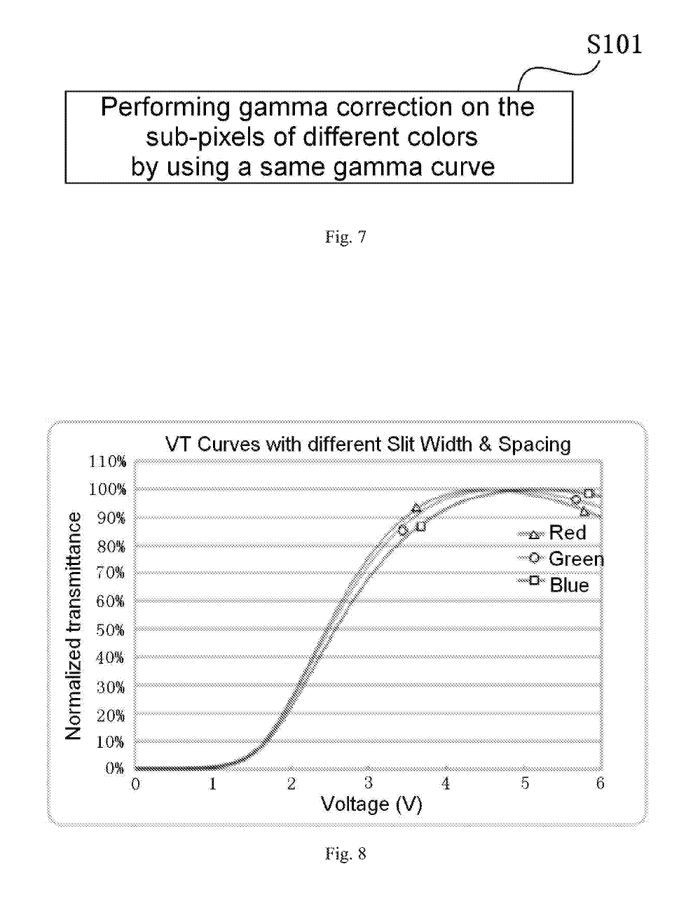

In addition, the embodiments of the present invention further provide a driving method of a pixel structure, used for driving the pixel structure according to the embodiments of the present invention. As shown in FIG. 7, the driving method includes: performing gamma correction on the sub-pixels of different colors by using a same gamma curve (S101). Compared with the prior art, by the driving method of the pixel structure according to the embodiments of the present invention, the brightness ratios of sub-pixels of different colors are made consistent in different gray scales in a simpler way, no reduction of the transmittance of the LCD after gamma correction is ensured at the same time, and thus the quality o the image displayed on the LCD is thus improved.

The forgoing implementations are merely exemplary implementations of the present invention, and the protection scope of the present invention is not limited thereto. Any changes or substitutions that may be envisaged by a person of ordinary skill in the art without departing from the technical scope disclosed by the present invention should be considered to be encompassed in the protection scope of the present invention. Therefore, the protection scope of the present invention is subjected to that of the appended claims.

1. A pixel structure, comprising sub-pixels of at least two colors, each of the sub-pixels comprising a plate electrode and a slit electrode provided to be insulated from each other, wherein the slit electrodes included in the sub-pixels of different colors are configured to have different structures to make voltage-transmittance curves of the sub-pixels of different colors consistent.

2. The pixel structure according to claim 1, wherein at least one of widths of electrodes, widths of slits and included angles between the slits and arrangement directions of the sub-pixels, of the slit electrodes included in the sub-pixels of different colors, are different.

3. The pixel structure according to claim 2, wherein
included angles between the slits of the slit electrodes included in the sub-pixels of different colors and the arrangement directions of the sub-pixels are the same, sums of widths of electrodes and widths of slits of the slit electrodes included in the sub-pixels of different colors are the same, and both widths of electrodes and widths of slits of the slit electrodes included in the sub-pixels of different colors are different.

4. The pixel structure according to claim 2, wherein
the pixel structure comprises a red sub-pixel, a green sub-pixel, and a blue sub-pixel; and
the red sub-pixel comprises a first slit electrode, the green sub-pixel comprises a second slit electrode, and the blue sub-pixel comprises a third slit electrode.

5. The pixel structure according to claim 4, wherein
included angles between slits of the first slit electrode, the second slit electrode and the third slit electrode and the arrangement directions of the sub-pixels are the same, sums of widths of electrodes and widths of slits of the first slit electrode, the second slit electrode and the third slit electrode are the same, widths of electrodes of the first slit electrode, the second slit electrode and the third slit electrode increase in this order, and widths of slits of the first slit electrode, the second slit electrode and the third slit electrode decrease in this order.

6. The pixel structure according to claim 5, wherein
width of each of the red sub-pixel, the green sub-pixel and the blue sub-pixel is 26 μm and length thereof is 78 μm, and sum of the width of electrode and the width of slit of each of the first slit electrode, the second slit electrode and the third slit electrode is 6.2 μm;
the width of electrode of the first slit electrode is 1.8 μm, and the width of slit of the first slit electrode is 4.4 μm;
the width of electrode of the second slit electrode is 2.1 μm, and the width of slit of the second slit electrode is 4.1 μm; and
the width of electrode of the third slit electrode is 2.8 μm, and the width of slit of the third slit electrode is 3.4 μm.

7. The pixel structure according to claim 2, wherein
included angles between slits of the slit electrodes included in the sub-pixels of different colors and the arrangement directions of the sub-pixels are the same, sums of widths of electrodes and widths of slits of the slit electrodes included in the sub-pixels of different colors are different, and both widths of electrodes and widths of slits of the slit electrodes included in the sub-pixels of different colors are different.

8. The pixel structure according to claim 7, wherein
the pixel structure comprises a red sub-pixel, a green sub-pixel, and a blue sub-pixel;
the red sub-pixel comprises a first slit electrode, the green sub-pixel comprises a second slit electrode, and the blue sub-pixel comprises a third slit electrode;
width of each of the red sub-pixel, the green sub-pixel and the blue sub-pixel is 26 μm, and length thereof is 78 μm;
sum of width of electrode and width of slit of the first slit electrode is 5.1 μm, the width of electrode of the first slit electrode is 2.1 μm, and the width of slit of the first slit electrode is 3.0 μm;
sum of width of electrode and width of slit of the second slit electrode is 5.9 μm, the width of electrode of the second slit electrode is 2.3 μm, and the width of slit of the second slit electrode is 3.6 μm; and
sum of width of electrode and width of slit of the third slit electrode is 6.2 μm, the width of electrode of the third slit electrode is 2.8 μm, and the width of slit of the third slit electrode is 3.4 μm.

9. The pixel structure according to claim 2, wherein
included angles between slits of the slit electrodes included in the sub-pixels of different colors and the arrangement directions of the sub-pixels are different, and any of widths of electrodes and widths of slits of the slit electrodes included in the sub-pixels of different colors are the same.

10. An array substrate comprising the pixel structure according to claim 1.

11. A display device, comprising the array substrate according to claim 10.

12. A driving method of a pixel structure, used for driving the pixel structure according to claim 1, wherein the method comprises:
performing gamma correction on the sub-pixels of different colors by using a same gamma curve.

13. The display device according to claim 11, wherein at least one of widths of electrodes, widths of slits and included angles between the slits and arrangement directions of the sub-pixels, of the slit electrodes included in the sub-pixels of different colors, are different.

14. The display device according to claim 13, wherein
included angles between the slits of the slit electrodes included in the sub-pixels of different colors and the arrangement directions of the sub-pixels are the same, sums of widths of electrodes and widths of slits of the slit electrodes included in the sub-pixels of different colors are the same, and both widths of electrodes and widths of slits of the slit electrodes included in the sub-pixels of different colors are different.

15. The display device according to claim 13, wherein
the pixel structure comprises a red sub-pixel, a green sub-pixel, and a blue sub-pixel; and
the red sub-pixel comprises a first slit electrode, the green sub-pixel comprises a second slit electrode, and the blue sub-pixel comprises a third slit electrode.

16. The display device according to claim 15, wherein
included angles between slits of the first slit electrode, the second slit electrode and the third slit electrode and the arrangement directions of the sub-pixels are the same, sums of widths of electrodes and widths of slits of the first slit electrode, the second slit electrode and the third slit electrode are the same, widths of electrodes of the first slit electrode, the second slit electrode and the third slit electrode increase in this order, and widths of slits of the first slit electrode, the second slit electrode and the third slit electrode decrease in this order.

17. The display device according to claim 16, wherein
width of each of the red sub-pixel, the green sub-pixel and the blue sub-pixel is 26 μm and length thereof is 78 μm, and sum of the width of electrode and the width of slit of each of the first slit electrode, the second slit electrode and the third slit electrode is 6.2 μm;
the width of electrode of the first slit electrode is 1.8 μm, and the width of slit of the first slit electrode is 4.4 μm;
the width of electrode of the second slit electrode is 2.1 μm, and the width of slit of the second slit electrode is 4.1 μm; and
the width of electrode of the third slit electrode is 2.8 μm, and the width of slit of the third slit electrode is 3.4 μm.

18. The display device according to claim 13, wherein
included angles between slits of the slit electrodes included in the sub-pixels of different colors and the arrangement directions of the sub-pixels are the same, sums of widths of electrodes and widths of slits of the slit electrodes included in the sub-pixels of different colors are different, and both widths of electrodes and widths of slits of the slit electrodes included in the sub-pixels of different colors are different.

19. The display device according to claim 18, wherein
the pixel structure comprises a red sub-pixel, a green sub-pixel, and a blue sub-pixel;
the red sub-pixel comprises a first slit electrode, the green sub-pixel comprises a second slit electrode, and the blue sub-pixel comprises a third slit electrode;
width of each of the red sub-pixel, the green sub-pixel and the blue sub-pixel is 26 μm, and length thereof is 78 μm;
sum of width of electrode and width of slit of the first slit electrode is 5.1 μm, the width of electrode of the first slit electrode is 2.1 μm, and the width of slit of the first slit electrode is 3.0 μm;
sum of width of electrode and width of slit of the second slit electrode is 5.9 μm, the width of electrode of the second slit electrode is 2.3 μm, and the width of slit of the second slit electrode is 3.6 μm; and
sum of width of electrode and width of slit of the third slit electrode is 6.2 μm, the width of electrode of the third slit electrode is 2.8 μm, and the width of slit of the third slit electrode is 3.4 μm.

20. The display device according to claim 13, wherein
included angles between slits of the slit electrodes included in the sub-pixels of different colors and the arrangement directions of the sub-pixels are different, and any of widths of electrodes and widths of slits of the slit electrodes included in the sub-pixels of different colors are the same.
